(19) United States
(12) Patent Application Publication
(10) Pub. No.: US 2026/0187704 A1
(43) Pub. Date: Jul. 2, 2026

(54) SYSTEM AND METHOD FOR REAL-TIME VOICE-BASED ORDER PROCESSING

(71) Applicant: NCR Voyix Corporation, Atlanta, GA (US)

(72) Inventors: Max Groves, Atlanta, GA (US); Perry Kankam, Atlanta, GA (US)

(21) Appl. No.: 19/004,630

(22) Filed: Dec. 30, 2024

(51) Int. Cl. G06Q 30/0601; G10L 15/183; G10L 15/22; G10L 15/30

(52) U.S. Cl. CPC G06Q 30/0633; G06Q 30/0641; G10L 15/183; G10L 15/22; G10L 15/30

(57) ABSTRACT

A system and method provide real-time voice-based order processing in an order terminal. A schema is generated that defines all possible orders, all possible options for each of the possible orders, and an output format for defining a user order. Audio signals are received representing an order spoken by a user. The received audio signals are transcribed via an artificial intelligence transcription model trained to recognize speech in real time to generate a transcribed text stream. The transcribed text stream and the generated schema are provided to a large language model (LLM) for processing the transcribed text stream to identify order information based on the generated schema. The LLM provides the identified order information in an output arranged according to the output format in the generated schema. The output from the LLM is received and a current transaction list is updated based on the identified order information in the output.

### FIELD

This disclosure relates generally to a system and method for real-time voice-based order processing, and more particularly to a system and method for real-time voice-based order processing based on analysis by a large language model.

### BACKGROUND

Conventional voice assistants and emerging voice artificial intelligence (AI) interfaces are extremely limited in execution and struggle to handle complex, multi-part user requests efficiently. Conventional voice assistants have very narrow feature sets that rely on self-training. Emerging voice artificial intelligence (AI) interfaces replicate existing conversations but do not improve upon existing patterns and introduce delays from processing the audio. These prior systems tend to operate within narrow scopes and struggle to accommodate complex, multi-step requests efficiently, often requiring repetitive user inputs or clarifications. These drawbacks make it difficult to incorporate such prior systems into point of sale terminals to implement voice-based order processing.

These challenges highlight the need for an enhanced system and method for real-time voice-based order processing that creates a seamless, real-time experience allowing a user to make highly customized and detailed requests in a single interaction without interruption or extensive manual adjustment.

### SUMMARY

The system and method of the present disclosure addresses the limitations of existing voice-controlled systems by introducing a real-time, local AI transcription model that converts user speech into text and passes the transcribed text to a large language model (LLM) using a mandatory return object schema. This schema outlines the application state and request payload, allowing users to provide highly complex and customized orders in a single breath without the need for extensive menus or selections. As the user speaks, the LLM continuously processes the speech and provides order updates for the visual display in real-time, providing immediate feedback on the status of the current order or request.

### BRIEF DESCRIPTION OF THE DRAWINGS

The following detailed description, given by way of example and not intended to limit the present disclosure solely thereto, will best be understood in conjunction with the accompanying drawings in which:

FIG. 1 is a block diagram of a system for real-time voice-based order processing according to an aspect of the current disclosure;

FIG. 2 is a flow diagram of a method for real-time voice-based order processing for use in the system of the current disclosure; and

FIG. 3 is a block diagram of a computing device for use in the system of the current disclosure.

### DETAILED DESCRIPTION

In the present disclosure, like reference numbers refer to like elements throughout the drawings, which illustrate various exemplary embodiments of the present disclosure.

The system and method of the present disclosure provides a modular solution that can be adapted to various applications, such as a food-ordering kiosk or terminals for managing loyalty accounts, scheduling future orders, or handling other business operations. The core technology of the system and method of the present disclosure enables seamless, highly interactive, and intuitive user experiences without relying on vocal responses to the user, thereby enhancing efficiency and usability. The instant disclosure describes the system and method in terms of a user thereof. It is to be recognized that in most situations, the user is a customer.

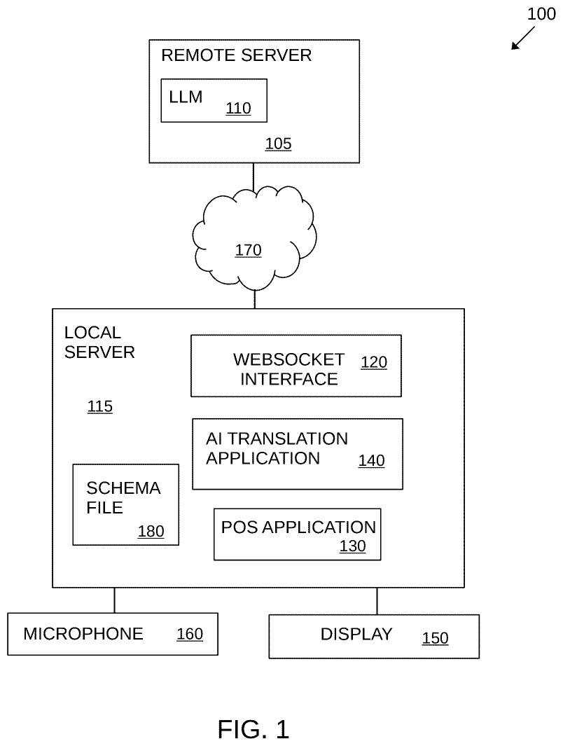

Referring now to FIG. 1, a system 100 according to the present disclosure includes a local server 115 that may be configured to operate as a point of sale (POS) terminal. The local server 115 operates according to a POS application 130 and is coupled to a microphone 160 and a display 150. The local server 115 includes an AI transcription model 140 for transcribing user speech received from microphone 160 into text with minimal latency. Because the AI transcription model 140 operates locally, the user data remains private and potential latency and privacy concerns are reduced over cloud-based remote transcription operations. The AI transcription model 140 is preferably a deep learning-based automatic speech recognition system such as OpenAI Whisper developed by Open AI or equivalent products that provide high accuracy and real-time transcription.

The local server 115 also includes a WebSocket interface 120 for communicating with a large language model (LLM) 110 on a remote server 105 via a network 170, which may be a wide area network such as the Internet. The use of the WebSocket interface 120 provides for continuous two-way communication between the local server 115 and the remote server 105 and thus provides much lower latency that would other types of network communications, e.g., HTTP/HTTPS.

A schema file 180 is stored in a non-volatile memory of local server 115. The schema file 180 is predefined based on the type of product or services provided by the terminal and defines, at least, all possible orders, all possible options for each of the possible orders, and an output format for defining a user order.

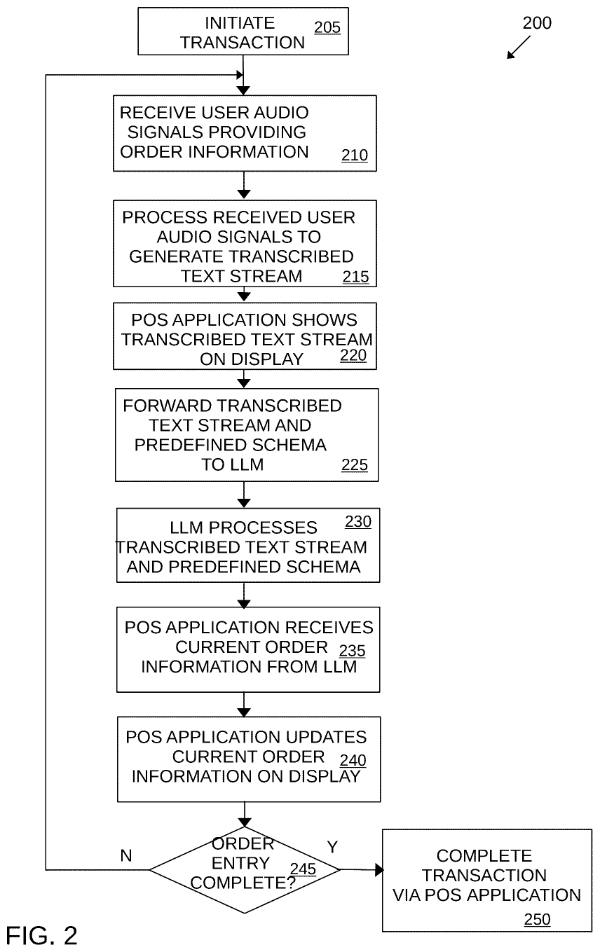

Referring now to FIG. 2, a flowchart 200 of a method according to the present disclosure is shown. A transaction is first initiated, step 205,when the user begins to speak into the microphone 160. The speech, in audio signal form, from the microphone is digitized and provided as an input to the AI transcription application 140, step 210, which processes the input to generate a transcribed text stream output based on the input digitized audio signals. By using a local AI model (AI transcription application 140) to transcribe spoken input into text, latency is minimized so that the user experience is enhanced. Furthermore, the use of a local AI model ensures privacy and security by not relying on cloud processing of the digitized audio signals.

Once the speech is transcribed, the transcribed text stream is forwarded to display 160 to provide a feedback signal on the display to the user (step 220) of the transcription of the user input.

The transcribed text stream and a predefined schema (e.g., schema file 180) is forwarded to the LLM 110 at step 225, preferably using the WebSocket interface 120. The predefined schema defines, at least, the structure of the request payload and the structure of the requested output. The structure of the request payload defines the options available from the POS terminal, e.g., the menu items available from a restaurant associated with the POS terminal, and the structure of the requested output, i.e., how the LLM 110 is to specify the items actually requested by the user's spoken words. The user may say, in one example request: “ok, I need a burger with everything on it, also give it 4 beef patties, 6 slices of cheese, and no bun . . . also give me 4 hot dogs but make one hot dog with cheese and another dog vegan.” In overview, the predetermined schema is generated before use of the system and method of the present disclosure to define all of the possible orders available, all of the possible options for each of the possible orders, and an output format for defining a user order.

The LLM 110 dynamically processes the received text stream and predetermined schema at step 230 to identify order information in the received text stream based on the information in the predefined schema.

Then, the LLM 110 provides current order information, preferably formatted as a structured JSON object that specifies the items requested by the user, to the POA application 130 in the local server 115, at step 235. This current order information is formatted according to information in the predefined schema and includes the order information as determined by the LLM 110 in response to the received transcribed text stream in view of the available options (e.g., the menu) in the predefined schema.

The POA application 130 updates the display 150, at step 240, to show the current status of the order based on the received structured JSON object, ensuring that the state of the transaction is maintained current and visible to the user on the display 150 as the user speaks.

The process of transcribing and processing the received user speech continues so long as the user continues to speak, indicating that the order is not complete at step 245, with processing reverting to step 210 so that the order for the current transaction is continuously updated by the POS application 130.

When the user ends the transaction, by specifying that the order is complete verbally or when the user cease speaking for a predetermined period, processing moves to step 250, where the POS application 130 tabulates the order and provides the user with the ability to finalize the transaction, e.g., by payment using an appropriate interface.

Based on the foregoing process, the LLM 110 is able to continuously process the user's speech in real time, breaking down user request into actionable computational steps and responding with a structured JSON object. This object structured JSON is provided to the POS application 130 so that user's order is updated in real time as the user continues to speak. This continuous feedback loop ensures that the display 150 remains up-to-date with the user's evolving request, without any need to provide an auditory response to the user. Moreover, because the LLM 110 is provided with a predefined schema that defines the all possible ordering possibilities, the system can handle unexpected or unsupported inputs by recognizing when a user has requested something outside the defined schema. In such cases, the LLM 110 will provide a message, via the JSON object, which instructs the POS application 130 to request user clarification or modification of the current order, ensuring that even complex or non-standard inputs are efficiently managed. Because the architecture of the system and method of the present disclosure relies on a predetermined schema, it is highly modular and can support a wide range of applications. The predetermined schema can be adapted to handle tasks such as loyalty management, scheduling future orders, or other complex user requests.

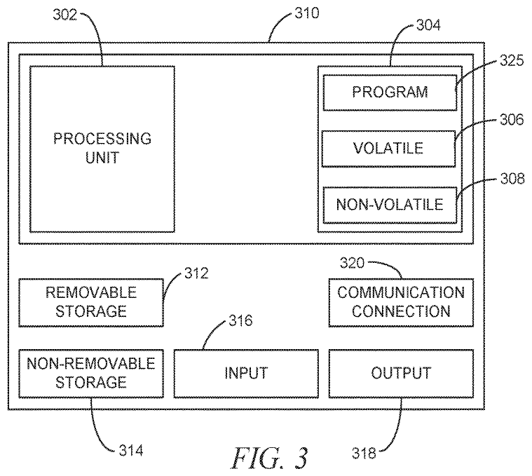

FIG. 3 is a block diagram of a computing device 310, according to an example embodiment, for use in the system and method of the present disclosure. Each of the remote server 105 and the local server 115 in FIG. 1 may be implemented as a computing device 310. In one embodiment, multiple such computer systems are utilized in a distributed network to implement multiple components in a transaction-based environment. An object-oriented, service-oriented, or other architecture may be used to implement such functions and communicate between the multiple systems and components. One example computing device in the form of a computer 310, may include a processing unit 302, memory 304, removable storage 312, and non-removable storage 314. Memory 304 may include volatile memory 306 and non-volatile memory 308. Computer 310 may include or have access to a computing environment that includes a variety of computer-readable media, such as volatile memory 306 and non-volatile memory 308, removable storage 312 and non-removable storage 314. Computer storage includes random access memory (RAM), read-only memory (ROM), erasable programmable read-only memory (EPROM) and electrically erasable programmable read-only memory (EEPROM), flash memory or other memory technologies, compact disc read-only memory (CD-ROM), Digital Versatile Disks (DVD) or other optical disk storage, magnetic cassettes, magnetic tape, magnetic disk storage or other magnetic storage devices, or any other medium capable of storing computer-readable instructions. Computer 310 may include or have access to a computing environment that includes input 316 (e.g., microphone 160 in FIG. 1), output 318 (display 150 in FIG. 1), and a communication connection 320. The computer may operate in a networked environment using a communication connection to connect to one or more remote computers, such as database servers. The remote computer may include a personal computer (PC), server, router, network PC, a peer device or other common network node, or the like. The communication connection may include a Local Area Network (LAN), a Wide Area Network (WAN) or other networks.

Computer-readable instructions stored on a computer-readable medium are executable by the processing unit 302 of the computer 310. A hard drive, CD-ROM, and ROM are some examples of articles constituting a non-transitory computer-readable medium. For example, a computer program 325 capable of performing one or more of the methods or providing one or more functions illustrated and described herein.

Although the present disclosure has been particularly shown and described with reference to the preferred embodiments and various aspects thereof, it will be appreciated by those of ordinary skill in the art that various changes and modifications may be made without departing from the spirit and scope of the disclosure. It is intended that the appended claims be interpreted as including the embodiments described herein, the alternatives mentioned above, and all equivalents thereto.

What is claimed is:

1. A method for real-time voice-based order processing in an order terminal, comprising:
generating a schema that defines all possible orders, all possible options for each of the possible orders, and an output format for defining a user order;
receiving audio signals representing an order spoken by a user;
transcribing the received audio signals via an artificial intelligence (AI) transcription model trained to recognize speech in real time to generate a transcribed text stream, the AI transcription model located locally to the order terminal;
providing the transcribed text stream and the generated schema to a large language model (LLM) for processing the transcribed text stream to identify order information based on the generated schema, wherein the LLM provides the identified order information in an output arranged according to the output format in the generated schema; and
receiving the output from the LLM and updating a current transaction list based on the identified order information in the output.

2. The method of claim 1, wherein the transcribed text stream is provided to a display to provide the user with real time feedback of the spoken order during a current transaction.

3. The method of claim 1, wherein the identified order information from the LLM is provided to a display to provide the user with real time feedback of the identified order during a current transaction.

4. The method of claim 1, wherein the LLM is located on a server located remotely from the order terminal.

5. The method of claim 4, wherein the order terminal is coupled to the LLM on the remotely located server via a wide area network.

6. The method of claim 5, wherein the order terminal communicates with the LLM on the remotely located server via a WebSocket interface.

7. The method of claim 1, wherein the AI transcription model is OpenAI Whisper.

8. The method of claim 1, wherein the output from the LLM is provided in JSON object format.

9. The method of claim 1, wherein the order terminal is associated with a restaurant and wherein the generated schema defines all possible menu items and all possible options for each of the possible menu items.

10. The method of claim 1, wherein the LLM provides, as part of the output, a message requesting user clarification when the transcribed text stream requests something not included in the generated schema.

11. A system for real-time voice-based order processing in an order terminal, comprising:
a server comprising at least one processor and an non-transitory computer-readable storage medium,
the non-transitory computer-readable storage medium comprising a schema file that defines all possible orders, all possible options for each of the possible orders, and an output format for defining a user order;
the non-transitory computer-readable storage medium comprising executable instructions which, when executed by at least one processor in the server, cause the at least one processor to perform operations, comprising:
receiving audio signals representing an order spoken by a user;
transcribing the received audio signals via an artificial intelligence (AI) transcription model trained to recognize speech in real time to generate a transcribed text stream, the AI transcription model located locally to the order terminal;
providing the transcribed text stream and the schema file to a large language model (LLM) for processing the transcribed text stream to identify order information based on the schema file, wherein the LLM provides the identified order information in an output arranged according to the output format in the schema file; and
receiving the output from the LLM and updating a current transaction list based on the identified order information in the output.

12. The system of claim 11, wherein the transcribed text stream is provided to a display to provide the user with real time feedback of the spoken order during a current transaction.

13. The system of claim 11, wherein the identified order information from the LLM is provided to a display to provide the user with real time feedback of the identified order during a current transaction.

14. The system of claim 11, wherein the LLM is located on a server located remotely from the order terminal.

15. The system of claim 14, wherein the order terminal is coupled to the LLM on the remotely located server via a wide area network.

16. The system of claim 15, wherein the order terminal communicates with the LLM on the remotely located server via a WebSocket interface.

17. The system of claim 11, wherein the AI transcription model is OpenAI Whisper.

18. The system of claim 11, wherein the output from the LLM is provided in JSON object format.

19. The system of claim 11, wherein the order terminal is associated with a restaurant and wherein the schema file defines all possible menu items and all possible options for each of the possible menu items.

20. The system of claim 11, wherein the LLM provides, as part of the output, a message requesting user clarification when the transcribed text stream requests something not included in the schema file.
